(19) United States
(12) Patent Application Publication
(10) Pub. No.: US 2012/0004812 A1
(43) Pub. Date: Jan. 5, 2012

(54) DRIVER ASSISTANCE SYSTEM FOR AGRICULTURAL WORKING MACHINE

(76) Inventors: Joachim Baumgarten, Beelen (DE); Sebastian Neu, Bar Laer (DE); Christoph Bussmann, Harsewinkel (DE); Andreas Wilken, Bissendorf (DE); Henner Voecking, Rietberg (DE); Christoph Heitmann, Warendorf (DE)

(21) Appl. No.: 13/113,270

(22) Filed: May 23, 2011

(30) Foreign Application Priority Data
Jul. 1, 2010 (DE) 10 2010 017 676.1

(51) Int. Cl. G06F 17/00

(52) U.S. Cl. 701/50

(57) ABSTRACT

A driver assistance system for agricultural working machines, such as a combine harvester having a large number of working mechanisms, is formed by at least one data processing and control unit, and at least one display unit, and the data processing and control unit processes information generated by sensor systems internal to the machine, information that can be stored in the data processing and control unit, and/or external information, and the driver assistance system has selectable process implementation strategies, and the selection criterium of a process implementation strategy are the quality required for a certain intended use of the crop and/or optimization criteria of the working mechanisms.

### CROSS-REFERENCE TO RELATED APPLICATION

The invention described and claimed hereinbelow is also described in German Patent Application DE 10 2010 017 676.1 filed on Jul. 1, 2010. This German Patent Application, whose subject matter is incorporated here by reference, provides the basis for a claim of priority of invention under 35 U.S.C. 119(a)-(d).

### BACKGROUND OF THE INVENTION

The present invention relates to a driver assistance system for agricultural working machines.

DE 101 47 733 made known a driver assistance system that supports the operator of an agricultural working machine in the optimization of the working parameters of the working mechanisms. The driver assistance system includes a complex display unit as well as an arithmetic logic unit for processing various sensor signals. The agricultural working machine, which is designed as a combine harvester, includes a large number of working mechanisms, e.g., a header, a threshing mechanism, separating parts, and at least one cleaning mechanism, which are coupled to a large number of sensing devices capable of detecting working parameters of the working mechanisms as well as efficiency parameters of the agricultural working machine, such as grain loss, grain quality, and tailings quantity.

The information that is ascertainable using the sensing devices is forwarded to the central arithmetic logic unit which derives information from these signals that may be visualized in the display unit. The visualized information includes working parameters of the agricultural working machine, such as cylinder speed, cleaning fan speed, crop material throughput, and concave width, as well as efficiency parameters such as the grain loss from the cleaning and separating mechanisms. To optimize the various working parameters, a method is provided in DE 101 47 733, in which, in a first method step, the operator guides the agricultural working machine through the stand to be harvested at a ground speed that is appropriate for the expected crop material throughput, thereby ensuring that the combine harvester is acted upon by an approximately consistent quantity of crop material within a certain time period. The operator must wait until the combine harvester has reached a state of equilibrium in which an approximately consistent, good or bad working result is attained. This working result is recorded, and it is visualized to the operator in the display unit. If the working result is unsatisfactory, the operator of the combine harvester makes repeated changes to a promising working parameter of a working mechanism, and, each time, waits for the combine harvester to reach a state of equilibrium with the modified working parameter. All of the working results are recorded as a function of time, thereby enabling the operator to identify the specific value of the working parameter at which the best working result was attained. This specific value is then used to adjust the particular working mechanism, thereby ensuring that an improved working result of the agricultural working machine is ultimately attained.

A method of this type has the main disadvantage that a relatively long period of time is required before the various working parameters of the combine harvester function within an optimized parameter range, since the disclosed adjustment procedure must be implemented for every working parameter. In addition, in the case of an adjustment method structured in this manner, performing optimization rapidly and successfully is decisively dependent on the level of knowledge of the operator of the agricultural working machine, since the various working parameters influence one another via highly complex interactions. In addition, given an optimization method structured in this manner, it is nearly impossible to fulfill customer-specific requirements on the crop material.

### SUMMARY OF THE INVENTION

The problem addressed by the invention is therefore that of avoiding the above-described disadvantages of the related art and, in particular, of providing a driver assistance system for optimizing the efficiency of an agricultural working machine which ensures that the agricultural working machine reaches an operating state that is optimized and adapted to the customer's preferences within the shortest amount of time possible.

Given that the agricultural working machine, which is designed as a combine harvester, comprises a driver assistance system which has selectable process implementation strategies, wherein the criterium for selecting a process implementation strategy is the quality of the crop required for a certain intended use, and/or criteria for optimization of the working mechanisms, it is ensured that the agricultural working machine reaches an operating state that is optimized and adapted to the customer's preferences within the shortest amount of time possible.

In an advantageous embodiment of the invention, the editable selection criterium includes “food plants”, “seed”, “feed plants” and/or “industrial plants”, thereby enabling an operating state of the agricultural working machine that is optimized specifically for the required quality of the crop to be attained for nearly every intended use of the crop material.

A process implementation strategy which can be carried out in a mathematically simple manner and ensures the necessary quality of the crop is attained in an advantageous development of the invention when each of these process implementation strategies accounts for one or more of the crop parameters “damaged grain”, “cleanliness”, and “threshed out material” such that,
when the selection criterium “food plants” is activated, regulation focusses on attaining an optimum of minimal “damaged grain”, maximum “threshed out material”, and maximum “cleanliness”
when the selection criterium “seed” is activated, regulation focusses on attaining minimal “damaged grain”, while “cleanliness” and “threshed out material” have a lower priority
when the selection criterium “feed plants” is activated, regulation focusses on attaining maximum “threshed out material”, while “cleanliness” and “damaged grain” have a lower priority
when the selection criterium “industrial plants” is activated, none of the crop parameters “damaged grain”, “cleanliness”, or “threshed out material” have priority.

A driver assistance system which can be adapted to customer-specific requirements in a particularly flexible manner is created when the dependencies of the crop parameters of a selection criterium, which are stored in characteristic curves or algorithms, are stored in the control/regulating unit in an editable manner.

Given that, in a further advantageous embodiment of the invention, every process implementation strategy can include, additionally or alternatively, the optimization criteria “maximum threshing quality” and/or “fuel-efficient” and/or “maximum throughput” and/or “balanced”, it is ensured that quality parameters pertaining directly to the quality of the crop as well as quality parameters related to the operating state of the agricultural working machine itself are taken into account. As a result, the agricultural working machine operates as precisely as necessary and as efficiently as possible.

A particularly simple and transparent handling of the driver assistance system is provided for the operator when the selection criteria and/or optimization criteria are displayed to the operator of the combine harvester in the display unit in a selectable manner, and the selection can be entered using a touchscreen function or buttons, and the process implementation strategy determined using the activated selection criterium and/or optimization criterium is carried out on the basis of characteristic curves or algorithms stored in the control/regulating unit.

The quality parameters related to the operating state of the agricultural working machine itself can be influenced in a particularly efficient manner in a further advantageous embodiment of the invention when the operating state of the working mechanisms can be controlled using automated regulating units, and the automated regulating units comprise, at the least, a ground speed regulator and/or an automated threshing mechanism and/or an automated separating mechanism and/or an automated cleaning mechanism.

To ensure that the operator of the agricultural working machine receives a more optimal understanding of the optimizations performed by the driver assistance system, it is provided according to an advantageous development of the invention that a notice field in the display unit provides the general notice regarding the effects that the process implementation strategy selected using the selection criterium or optimization criterium have on the mode of operation of the automated regulating units and/or the crop parameters.

A particularly flexible optimization of an agricultural working machine comprising a driver assistance system according to the invention is attained in an advantageous embodiment when the operating state of the automated regulating units can be edited, the editing is performed in a dialog-based manner in the display unit, and one or more automated regulating units can be turned on or off, or edited, by the editor or automatically using the control/regulating unit.

A particularly efficient support for the optimization of the agricultural working machine is attained in a further advantageous embodiment of the invention in that optimized adaptation suggestions for one or more automated regulating units are determined in the control/regulating unit, and are displayed to the operator in a dialog field in the display unit.

Given that the method according to the invention for operating an agricultural working machine comprising the driver assistance system according to the invention has the steps
the operator of the agricultural working machine is prompted, in a first menu step, to select the process implementation strategy, wherein the process implementation strategy alternatively or additionally includes the activation of a selection criterium which determines the quality of the crop, and/or the activation of an optimization criterium which determines the operating state of the working mechanisms
b.) depending on the process implementation strategy that has been selected, the operator is prompted, in the subsequent menu step, to select the selection criterium and/or to activate the automated regulating unit and the associated optimization criterium
c.) depending on the process implementation strategy activated by the operator of the agricultural working machine, the driver assistance system determines optimized working parameters for at least one working mechanism and causes the optimized working parameter to be set at the at least one working mechanism

it is ensured that the operator of the agricultural working machine can utilize an operating state of the agricultural working machine, which is optimized and adapted to the customer's preferences, in the shortest amount of time possible.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows an agricultural working machine designed as a combine harvester, which includes the driver assistance system according to the present invention.

FIG. 2 shows a schematic detailed view of the driver assistance system according to the invention.

FIG. 3 shows a flow chart of the method for operating the driver assistance system according to the invention.

FIG. 4 shows the layout of the display unit for determining the selection criteria of a first process implementation strategy.

FIG. 5 shows the layout of the display unit with activated notice fields in a first process implementation strategy.

FIG. 6 shows the layout of the display unit for determining the automated regulating units of a first process implementation strategy.

FIG. 7 shows the layout of the display unit for determining the optimization criteria of the automated regulating units of the further process implementation strategy.

### DESCRIPTION OF THE PREFERRED EMBODIMENTS

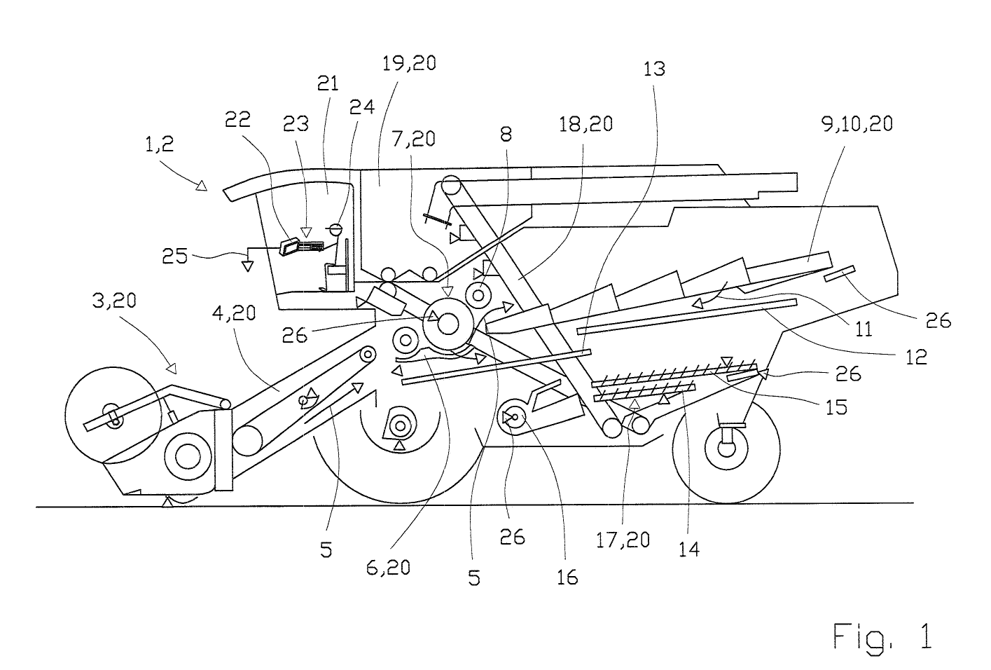

Agricultural working machine 1 which is designed as a combine harvester 2 and is depicted schematically in FIG. 1 includes a grain-cutting device 3 in its front region, which is connected in a manner known per se to feed rake 4 of combine harvester 2. Crop material flow 5 that passes through feed rake 4 is transferred in upper, rear region of feed rake 4 to threshing parts 7 of combine harvester 2, which are at least partially enclosed on the bottom by concave 6. A guide drum 8 situated downstream of threshing parts 7 redirects material flow 5 in the rear region of threshing parts 7 after it exits same in a manner such that it is transferred directly to a separating device 10 which is designed as a tray-type shaker 9 in the embodiment shown. It lies within the scope of the invention for combine harvester 2 to comprise, instead of tray-type shaker 9, a separating 10 which is known per se and is therefore not shown, and is designed as a separating rotor. Material flow 5 is conveyed on rotating tray-type shaker 9 in a manner such that any unencumbered grains 11 contained in the material flow are separated out in the region underneath tray-type shaker 9. Grains 11 that are separated out at concave 6 and on tray-type shaker 9 are directed via return pan 12 and feed pan 13 to a cleaning device 17 which is composed of several sieve levels 14, 15, and a fan 16. The cleaned flow of grain is then transferred via elevators 18 to a grain tank 19. Grain-cutting device 3, feed rake 4, threshing parts 7 and concave 6 assigned thereto, separating device 10, cleaning device 17, elevators 18, and grain tank 19 are referred to hereinbelow as working mechanisms 20 of agricultural working machine 1.

Agricultural working machine 1 also includes a driver's cab 21 in which at least one control/regulating unit 23 which includes a display device 22 is located, using which a large number of processes to be described in greater detail may be controlled, the processes being initiated automatically or by operator 24 of agricultural working machine 1. Control/regulating unit 23 communicates via a bus system 25 in a manner known per se with a large number of sensor systems 26. The structure of sensor systems 26 is described in detail in DE 101 47 733, the entire contents of which are hereby incorporated in the disclosure of this patent application, and so the structure of sensor systems 26 will not be described again hereinbelow.

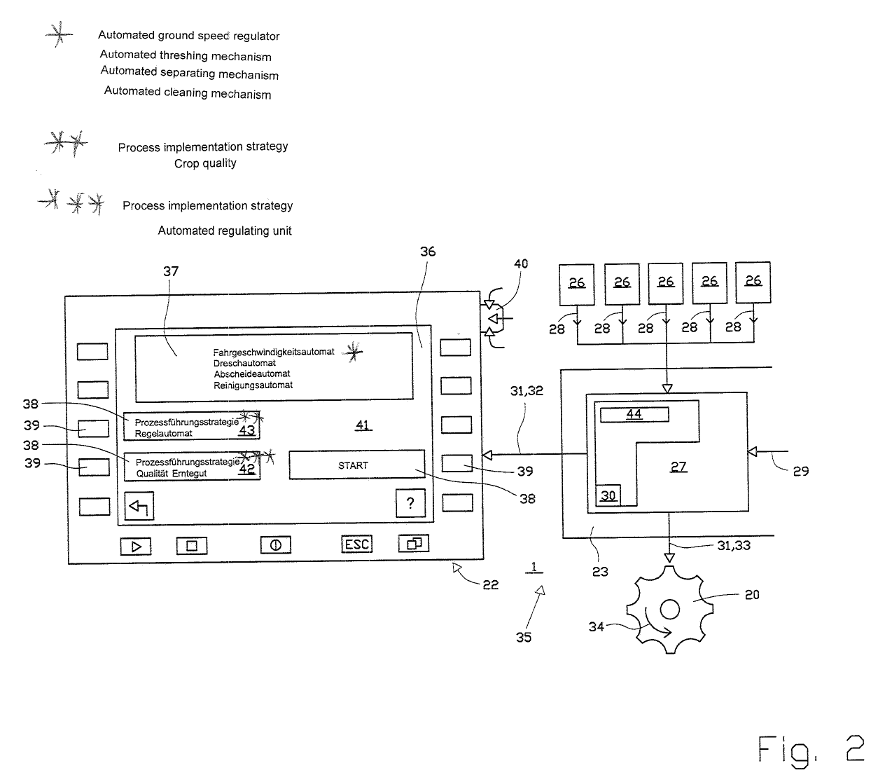

FIG. 2 shows a schematic depiction of display unit 22 of control/regulating unit 23, and arithmetic logic unit 27 which is assigned to control/regulating unit 23 and is coupled to display unit 22. Arithmetic logic unit 27 is designed such that it may process information generated by sensor systems 26, as well as external information 29, and information 30 stored in arithmetic logic unit 27 itself, such as, e.g., expert knowledge, to obtain a large number of output signals 31. Output signals 31 are designed such that they include, at the least, display control signals 32 and working mechanism signals 33; the former determine the contents of display unit 22, and the latter initiate the changing of highly diverse working parameters 34 of working mechanisms of agricultural working machine 1. Arrow 34 symbolizes the cylinder speed. Control/regulating unit 23, including display unit 22 and arithmetic logic unit 27 assigned to it, are components of driver assistance system 35 according to the present invention, display unit 22 of which enables interactive, natural-language communication to take place between operator 24 and driver assistance system 35 in a display area 36.

Display area 36 of display unit 22 comprises one or more notice fields 37 as well as selection fields 38 for activating various process sequences to be described in greater detail below. Particular selection field 38 is activated directly using buttons 39 assigned to particular selection field 38, and/or using a central navigation knob 40 which is rotated and pressed to navigate between various selection fields 38 and/or by operator 24 touching particular selection field 38 directly, provided display area 36 is designed as touchscreen monitor 41. FIG. 2 also shows the start layout of display area 36, wherein the selection button “Process implementation strategy: crop quality” 42 is used to select one of the process implementation strategies according to the invention and which will be described in greater detail below, the selection button “Process implementation strategy: automated regulating unit” 43 is activated in order to edit the automated regulating units according to the invention and which will also be described in greater detail below, and the selection button “Start” is used to activate driver assistance system 35. In the embodiment shown, information is visualized in notice field 37 regarding the activation of automated regulating units to be described and selected process implementation strategy 42, 43, combined with the question directed to the operator, asking him what he wants to do. After a selection field 38 has been activated, a software module 44 stored in the arithmetic logic unit 27 of control/regulating unit 23 is activated, which brings about an optimization of working parameters 34 of working mechanisms 20 using activated process implementation strategy 42, 43 and with consideration for information 30 stored in arithmetic logic unit 27, and external and internal information 28, 29 that is available.

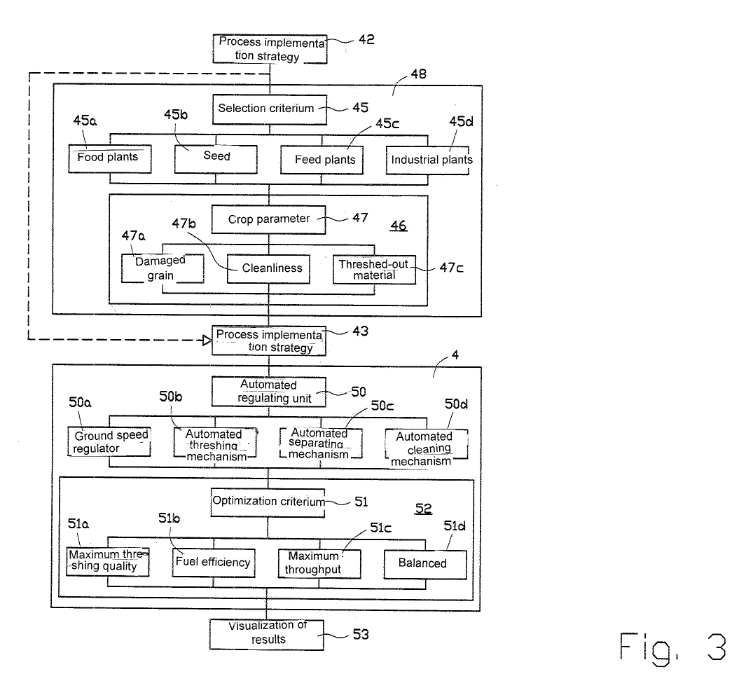

FIG. 3 shows, by reference to a flow chart, a schematic depiction of the method according to the invention for selecting, editing, and activating a process implementation strategy 42, 43 stored in arithmetic logic unit 27, wherein each of the process implementation strategies 42, 43 can be applied alternatively or in combination with the optimization of working parameters 34 of working mechanisms 20 of agricultural working machine 1. If the process implementation strategy “Crop quality” 42 is activated, an operating state of agricultural working machine 1 that is efficient and as precise as necessary is brought about under the particular conditions that are given. To this end, operator 24 of agricultural working machine 1 must select one selection criterium 45a-d from a large number of predefined selection criteria 45. Depending on the intended use and the associated, required quality of the crop to be harvested, process implementation strategies 42 are stored in driver assistance system 35 according to the invention for harvesting food plants (selection criterium 45a), seed (selection criterium 45b), feed plants (selection criterium 45c), and industrial plants (selection criterium 45d). Process implementation strategies 42 are implemented in the software in characteristic curves or algorithms 46 which, depending on particular selection criterium 45a-d, interconnect various crop parameters 47. The mathematical dependencies to be defined in characteristic curves 46 can have relatively simple structures when crop parameters 47 to be accounted for are limited to one or more of the crop parameters damaged grain 47a, cleanliness 47b, and threshed-out material 47c, wherein the general dependencies of various crop parameters 47a-c result as follows, depending on which selection criterium 45 has been selected:

If the selection criterium “food plants” 45a has been activated, regulation focusses on attaining an optimum of minimal damaged grain 47a, maximum threshed out material 47c, and maximum cleanliness 47b. If selection criterium “seed” 45b has been activated, regulation focusses on minimal damaged grain 47a, wherein crop parameters cleanliness 47b and threshed-out material 47c have a lower priority. If the selection criterium “feed plants” 45c has been activated, process implementation strategy 42 regulates toward maximum threshed-out material 47c, and crop parameters “cleanliness” 47b and “damaged grain” 47a have a lower priority. However, if the selection criterium “industrial plants” 45a has been activated, none of the crop parameters “damaged grain” 47a, “cleanliness” 47b, or “threshed-out material” 47c have priority. Instead, the objective is to achieve an optimization between said crop parameters 47. As described, when operator 24 activates particular selection criterium 45, a first optimization stage 48 of process implementation strategy 42 is carried out depending on the crop parameter, which ultimately results in an operating state of agricultural working machine 1 which is designed as combine harvester 2, which is adapted to the required quality of the crop material, which is grain 11 in this case.

It lies within the scope of the invention for the dependencies of various crop parameters 47 to be predefined in the characteristic curves or algorithms 46, or to be stored in an editable manner in control/regulating unit 23. In the latter case it is also feasible for stored characteristic curves 46 to be adapted to the specific conditions of the particular agricultural operation with input from the operator, wherein the operator can be the land manager, who is most familiar with his fields and specific farm conditions, external experts, or the particular manufacturer of agricultural working machine 1.

To further increase the efficiency of agricultural working machine 1, a further optimization stage 49 which represents the further process implementation strategy 43 and optimizes the operating state of automated regulating units 50 to be described in greater detail can be provided as an alternative or in addition. Automated regulating units 50 each relate to functional areas of agricultural working machine 1 and, in the embodiment shown, comprise a ground speed regulator 50a and/or an automated threshing mechanism 50b and/or an automated separating unit 50c and/or an automated cleaning unit 50d. It lies within the scope of the invention for further automated regulating units 50, such as a so-called automated front attachment or an automated straw chopper, to be defined, which can then likewise be edited, as selected or as needed, using further process implementation strategy 43, in a manner which is not depicted. The operating state of each automated regulating unit 50a-d can be optimized using optimization criteria 51 which are directed to the operating state of agricultural working machine 1 itself and to crop parameters 45. In the embodiment shown, optimization criteria 51 include the parameter “maximum threshing quality” 51a, the parameter “fuel-efficient operating state of agricultural working machine” 51b, the parameter “maximum throughtput” 51c, and the parameter “balanced” 51d, wherein the parameter “balanced” 51d represents an optimum of remaining parameters 51a-c. It lies within the scope of the invention for one, more, or all disclosed parameters 51a-d to be accounted for simultaneously in particular process implementation strategy 42.

The mathematical dependencies of various optimization criteria 51 relative to particular automated regulating unit 50a-d which has been activated, which are known per se and are therefore not described here in greater detail, are stored in characteristic curves or algorithms 52 in arithmetic control unit 27 of control/regulating unit 23, analogous to the activation of particular selection criterium 45, and can be described in general as follows:

If the optimization criterium “maximum threshing quality” 51a is activated, for example, ground speed regulator 50a regulates the ground speed and, therefore, the crop material throughout of agricultural working machine 1 depending on the grain losses. In the case of said optimization criterium 51a, automated threshing mechanism 50b regulates the parameters of threshing parts 7, such as the distance of concave 6 to threshing parts 7, and the rotational speed of threshing parts 7 such that intensive threshing and a low portion of damaged grain are attained. In the case of same optimization criterium 51, automated separating unit 50c ensures that the straw structure damage in crop material flow 5 in the region of separating device 10, preferably when rotating separating devices are used, are minimal, thereby ensuring that mainly grain 11 and minimal straw components are separated in the region of separating device 10. Finally, automated cleaning mechanism 50d ensures that, when the optimization criterium “maximum threshing quality” 51a is selected, a high level grain cleanliness is attained, and no non-threshed grain ears are conveyed into grain tank 19.

If optimization criterium “fuel efficient” 51b is activated, automated threshing mechanism 50b reduces the quality of the threshed-out material compared to previously described optimization criterium 51a in favor of lower fuel consumption, while still ensuring that the portion of broken grain is low. When optimization criterium 51b is activated, automated separating mechanism 50c functions substantially as it does when optimization criterium 51a is activated, although it aims to achieve the lowest energy consumption given a rotating separating unit 10, i.e. it aims to reduce the rotational speed of the rotor to a minimum. When a fuel-efficient operating state is required, automated cleaning mechanism 50d ensures that an optimum is achieved between crop quality and cleaning performance, wherein said optimum is decisively dependent on selection criterium 45 described above. Since a fuel-efficient operating state is determined to a decisive extent on the basis of the energy demand of the working mechanisms, ground speed regulator 50a is of secondary significance when the optimization criterium “fuel efficient” 51b is activated, and regulates the ground speed depending on the requirements of remaining automated regulating units 50b-50d. However, provided the parameters of remaining automated regulating units 50b-50d are in an optimal range, an energy-efficient operating state namely the highest possible grain throughput per liter of fuel, is achieved when the agricultural working machine is operated at the highest possible ground speed.

If the optimization criterium “maximum throughput” 51c has been activated, all automated regulating units 50 are operated at their performance limit, i.e. ground speed regulator 50a sets the maximum possible and permissible ground speed, automated threshing mechanism 50b drives threshing parts 7 to attain the maximum possible threshing output, automated separating mechanism 50c makes it possible to reach the maximum possible separating output, and automated cleaning mechanism 50d regulates cleaning mechanism 17 in an analogous manner into a range of maximum possible and permissible cleaning output. Since, given the precondition that the parameters of various automated regulating mechanisms 50 lie in an optimal range, “energy efficient” can also mean “maximum possible throughput”, the effect can occur that the optimization criteria “fuel efficient” 51b and “maximum throughput” 51c can induce the same regulating strategy.

However, if the optimization criterium “balanced” 51d is activated, automated threshing mechanism 50b is regulated such that it ensures optimal threshing with a low portion of damaged grain, and a high throughput. When optimization criterium 51d has been activated, automated separating mechanism 50c functions such that an optimum of maximum possible total throughput is attained with minimal damaged grain, minimal straw chopping, and high throughput. Given a balanced operating state of automated regulating mechanisms 50, automated cleaning mechanism 50d regulates cleaning unit 17 toward an optimum of grain cleanliness and required cleaning performance. Since a balanced operating state is determined to a decisive extent on the basis of the operating state of automated regulating mechanisms 50b-50d, ground speed regulator 50a is of secondary significance when the optimization criterium “balanced” 51d is activated, and regulates the ground speed depending on the requirements of remaining automated regulating units 50b-50d.

In a final method step 53, the parameters that were determined are visualized as shown in FIG. 3, wherein the type and manner of visualization is described in greater detail in the following.

According to FIG. 2 and the associated description, driver assistance system 35 according to the invention is started by operator 24 activating one of the selection fields 38 using buttons 39 or navigation knob 40 or via a touchscreen function.

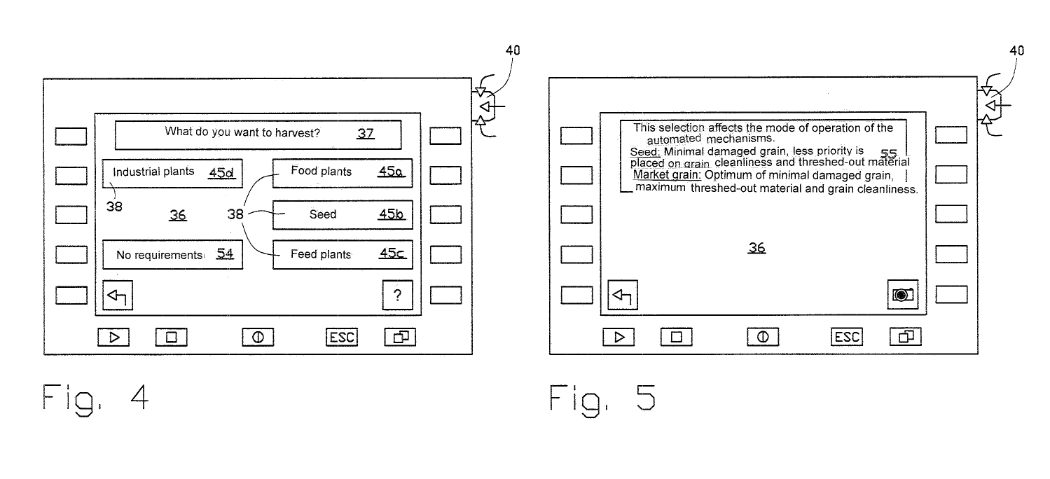

Since operator 24 activates the selection field “process implementation strategy ‘crop quality’” 42, activatable selection criteria 45—which are food plants 45a, seed 45b, feed plants 45c, and industrial plants 45d in this case—are visualized in display area 36 as shown in FIG. 4. Depending on the customer's preference, operator 24 will determine one of the selection criteria 45a-d by activating particular selection field 38. In a variant embodiment, information can first be displayed to operator 24 in a notice field 37, informing him of what he needs to do. In addition, a further selection field 54 can be provided, which, when activated, prevents a selection criterium 45a-d from being determined. This can be the case when the correct selection criterium 45a-d has already been activated, or when a selection criterium 45a-d is not supposed to be determined.

Provided a selection criterium 45a-d was selected, it can be provided in an advantageous embodiment according to FIG. 5 that a further notice window 55 is opened, in which operator 24 is shown dependencies and interactions between activated selection criterium 45a-d and automated regulating unit(s) 50a-d.

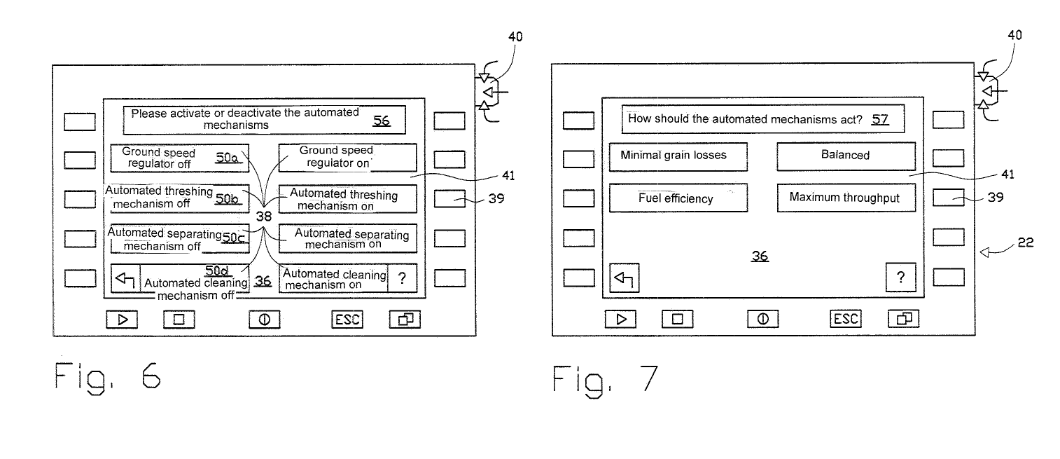

FIG. 6 shows the layout of display area 36 after operator 24 has started driver assistance system 35 and, in the start display layout shown in FIG. 2, has activated the selection field “process implementation strategy ‘automated regulating unit’” 43 using buttons 39, navigation knob 40, or a touchscreen function 41. Selection fields 38 which are now displayed include the activation or deactivation of ground speed regulator 50a, automated threshing mechanism 50b, automated separating mechanism 50c, and automated cleaning mechanism 50d. In a notice field, operator 24 can also be directly prompted to activate or deactivate automated regulating mechanisms 50. It lies within the scope of the invention for the activation or deactivation of automated regulating units 50 to also be performed automatically by control/regulating unit 23, wherein this automatic activation or deactivation is triggered, e.g. when it is detected that certain crop parameters 47 or the operating state of agricultural working machine 1 are becoming worse overall.

If operator 24 has edited automated regulating mechanism(s) 50, display unit 22 switches to the layout of display area 36 shown in FIG. 7. Various optimization criteria 51a-d are now visualized in display area 36, wherein each of the optimization criteria 51a-d can be activated using buttons 39, navigation knob 40, or via touchscreen function 41. In addition, operator 24 is informed via a notice field 57 what is expected of him in the visualized display layout.

If all selection criteria 45 and optimization criteria 51 have been determined, then, as shown in FIGS. 2 and 3, characteristic curves 46, 52 stored in software module 44 of control/regulating unit 23 are called up, and working parameters 34 of working mechanisms 20 of agricultural working machine 1 are optimized, and, depending on the embodiment, is implemented immediately at particular working mechanisms 20 via working mechanism signals 33 generated by control/regulating unit 23. Simultaneously, display unit 22 returns to the layout of display area 36 depicted in FIG. 2.

It will be understood that each of the elements described above, or two or more together, may also find a useful application in other types of constructions differing from the types described above.

While the invention has been illustrated and described as embodied in a driver assistance system for agricultural working machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A combine harvester, comprising a driver assistance system, a number of working mechanisms which process a crop material passing through the combine harvester, wherein the driver assistance system includes at least one data processing and control unit and at least one display unit, wherein the data processing and control unit processes information generated by sensor systems internal to the combine harvester, information stored in the data processing and control unit, external information and combinations thereof, wherein the driver assistance system has selectable process implementation strategies with a selection criterium of a process implementation strategy selected from the group consisting of a quality required for a certain intended use of the crop, an optimization criteria of the working mechanisms, and both.

2. The combine harvester according to claim 1, wherein the selection criterium comprise component selected from the group consisting of “food plants”, “seed”, “feed plants”, “industrial plants”, and combinations thereof.

3. The combine harvester according to claim 2, wherein said driver assistance system is configured so that each process implementation strategy accounts for one or more of the crop parameters “damaged grain”, “cleanliness” and “threshold out material” such that, when the selection criterium “food plants” has been activated, regulation focusses on attaining an optimum of minimal “damaged grain”, maximum “threshed out material”, and maximum “cleanliness”, when the selection criterium “seed” has been activated, regulation focusses on minimal “damaged grain”, and “cleanliness” and “threshed out material” has a lower priority, when the selection criterium “feed plants” is activated, regulation focusses on attaining maximal “threshed out material”, and “cleanliness” and “damaged grain” have a lower priority, and when the selection criterium “industrial plants” is activated, none of the crop parameters “damaged grain”, “cleanliness”, or “threshold-out material” have priority.

4. The combine harvester according to claim 3, further comprising a control/regulating unit configured so that dependencies of the crop parameters of a selection criterium stored in characteristic curves or algorithms are stored in the control/regulating unit in an editable manner.

5. The combine harvester according to claim 4, wherein said driver assistance system is configured so that the process implementation strategies comprise, additionally or alternatively, an optimization criteria selected from the group consisting of “maximum threshing quality” a “fuel efficient”, a “maximum throughput”, a “balanced”, and combinations thereof.

6. The combine harvester according to claim 5, further comprising a display unit in which a criteria selected from the group consisting of the selection criteria, the optimization criteria and both are stored in a selectable manner to an operator of the combine harvester in the display unit, and a selection can be made using a touchscreen function or buttons, and the process implementation strategy determined using a criteria selected from the group consisting of the activated selection criterium, the optimization criterium and both is implemented using characteristic curves or algorithms stored in the control/regulating unit.

7. The combine harvester according to claim 6, further comprising automated regulating mechanisms which control an operating state of the working mechanisms, and the automated regulating mechanisms comprise a mechanism selected from the group consisting of at least one ground speed regulator, one automated threshing mechanism, one automated separating mechanism, one automated cleaning mechanisms, and combinations thereof.

8. The combine harvester according to claim 6, wherein the display unit has a notice field which provides a general notice regarding effects that the process implementation strategy selected using the selection criterium or an optimization criterium has on a mode of operation of automated regulating units, the crop parameters, and both.

9. The combine harvester according to claim 1, further comprising a display unit in which an operating state of automated regulating units is edited in a dialog-based manner and one or more of the automated regulating units are turned on or off, or edited, by an editor or automatically using a control/regulating unit.

10. The combine harvester according to claim 9, wherein the control/regulating unit and the display unit are configured so that optimized adaptation suggestions for one or more of the automated regulating units are determined in the control/regulating unit, and are displayed to an operator in a dialog field in the display unit.

11. A method for operating a combine harvester according to claim 1, comprising the steps of prompting an operator of the agricultural working machine in a first menu step, to select the process implementation strategy, wherein the process implementation strategy alternatively or additionally includes an activation selected from the group consisting of an activation of a selection criterium which determines a quality of a crop, an activation of an optimization criterium which determines an operating state of the working mechanisms and combination thereof depending on the process implementation strategy that has been selected; prompting by the operator in a subsequent menu step, to select a selection criterium, to activate an automated regulating unit and an associated optimization criterium or both, depending on the process implementation strategy activated by the operator of the combine harvester; determining by the driver assistance system optimized working parameters for at least one working mechanism and causing the optimized working parameter to be set at least one of the working mechanisms.
